(19) United States
(12) Patent Application Publication
(10) Pub. No.: US 2015/0214599 A1
(43) Pub. Date: Jul. 30, 2015

(54) RADIO WAVE MONITORING APPARATUS

(71) Applicant: NEC Corporation, Tokyo (JP)

(72) Inventor: Tsuyoshi KAWAHARA, Tokyo (JP)

(73) Assignee: NEC Corporation

(21) Appl. No.: 14/605,253

(22) Filed: Jan. 26, 2015

(30) Foreign Application Priority Data
Jan. 28, 2014 (JP) 2014-013117

(51) Int. Cl. H01Q 1/12; H01Q 21/30

(52) U.S. Cl. CPC H01Q 1/1235; H01Q 21/30

(57) ABSTRACT

There is necessity of a method, when repairing and maintaining the H band antenna and M band antenna mounted on the upper part of the radio wave monitoring apparatus being installed in a high place, for performing replacement work easily without workers to climb the high place. By providing a hinge part 6 between the lower part support pole 2 and the central part support pole 7, it makes possible the central part support pole 7 bent to the operational possible range where workers can repair the H band antenna and the M band antenna.

This application is based upon and claims the benefit of priority from Japanese Patent Application No. 2014-013117, filed on Jan. 28, 2013, the disclosure of which is incorporated herein in its entirety by reference.

### TECHNICAL FIELD

The present invention relates to the structure of a multi-band antenna provided at an antenna upper part of a radio wave monitoring apparatus.

### BACKGROUND ART

In expanding work and removing work of a transportable antenna unit (especially a large type antenna), due to its structure, such work is needed as assembling each arm and antenna elements on a support pole by fastening with bolts, and connecting a cable to each arm. Because there are a lot of components required for each assembly, there is a problem that takes much time in expanding work and removing work of the transportable antenna unit.

In related art, it discloses a transportable antenna unit having the structure that arranges folding antenna elements, each of which is supported by a tip part of each folding arm being expanded radially from a support pole as a central axis, in array on the approximately identical circumference (patent document 1: Japanese Patent Application Laid-Open No. 2011-119812). This transportable antenna unit includes spring structure and a hinge mechanism. The spring structure is provided at a bottom of inside of a lower part of the support pole which contains the folding antenna elements and the folding arms in the folded state, and is used for pushing the folding arms up on an upper part of the support pole by elastic force when expanding. The hinge mechanism is something for making the folding arms expand in a horizontal direction toward outside at the upper part of the support pole, and for making the folding antenna elements expand in a direction orthogonal to each folding arm having been expanded in the horizontal direction at the tip part of the folding arm.

Further, a multi-band antenna which includes a plurality of antennas for receiving different frequency bands and for expanding reception enabled frequency bands is disclosed (Patent document 2: Japanese Patent Application Laid-Open No. 2012-169805).

Here, the multi-band antenna having a plurality of antennas exists. In a large type multi-band antenna in particular, at the time of performing replacement work, it is needed for workers to work at the upper part of the multi-band antenna of several meters in height mounted on a steel tower or on a building.

Moreover, changing the size such as the height is difficult because, in the multi-band antenna design, the installation interval has been determined in order to avoid radio interferences.

Therefore, it is needed for workers to climb the upper part when repairing and maintaining the antennas mounted on the upper part of the multi-band antenna being provided at a high place, and a problem that a burden on the workers is big has arisen.

### SUMMARY

An exemplary object of the present invention is to provide a multi-band antenna for which antenna repair by workers can be performed more efficiently.

### BRIEF DESCRIPTION OF THE DRAWINGS

Exemplary features and advantages of the present invention will become apparent from the following detailed description when taken with the accompanying drawings in which:

FIG. 1 is an exemplary general view of a multi-band antenna at the time of being fastened and assembled according to a first exemplary embodiment;

FIG. 2 is an exemplary detail view of an inclination part of the multi-band antenna at the time of being fastened and assembled according to the first exemplary embodiment;

FIG. 3 is an exemplary detail view of an inclination part of the multi-band antenna at the time of being released according to the first exemplary embodiment;

FIG. 4 is an exemplary general view of the multi-band antenna at the time of being released according to the first exemplary embodiment;

FIG. 5 is an exemplary general view of a multi-band antenna at the time of being fastened and assembled according to a second exemplary embodiment;

FIG. 6 is an exemplary general view of a multi-band antenna at the time of being fastened and assembled according to a third exemplary embodiment; and

FIG. 7 is an exemplary general view of a multi-band antenna at the time of being fastened and assembled according to a modification example of a forth exemplary embodiment.

### EXEMPLARY EMBODIMENT

### Features of the Present Invention

First, an outline about features of the present invention will be described prior to describing exemplary embodiments of the present invention.

In the multi-band antenna for which improvement of working efficiency is required, by providing a hinge between a lower part support pole and a central part support pole, the present invention makes an M band antenna and an H band antenna which are installed further above the central part support pole possible to be inclined so that it may become closer to the ground. As a result, it is characterized in realizing improved efficiency of replacement and repair work of this multi-band antenna by making it possible for workers performing the work without climbing the multi-band antenna. Here, the term “inclination” in the present invention means not only a movement of just inclining the central part support pole but also a movement of rotational transfer so that the central part support pole may approach an antenna installation surface.

By adopting the structure like above, it is possible to improve the efficiency of replacement work of the multi-band antenna because, when performing the replacement and repair work, the M band antenna and the H band antenna can be moved to a range where workers can perform the work.

### First Exemplary Embodiment

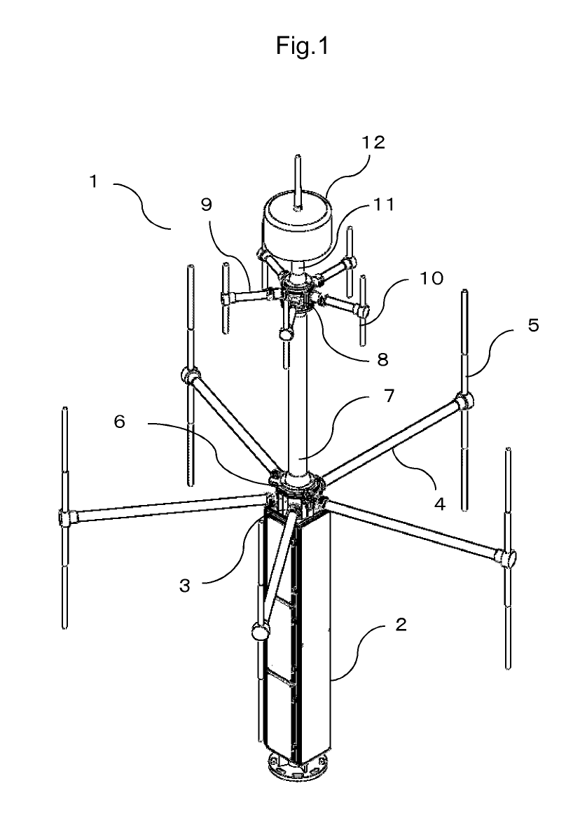

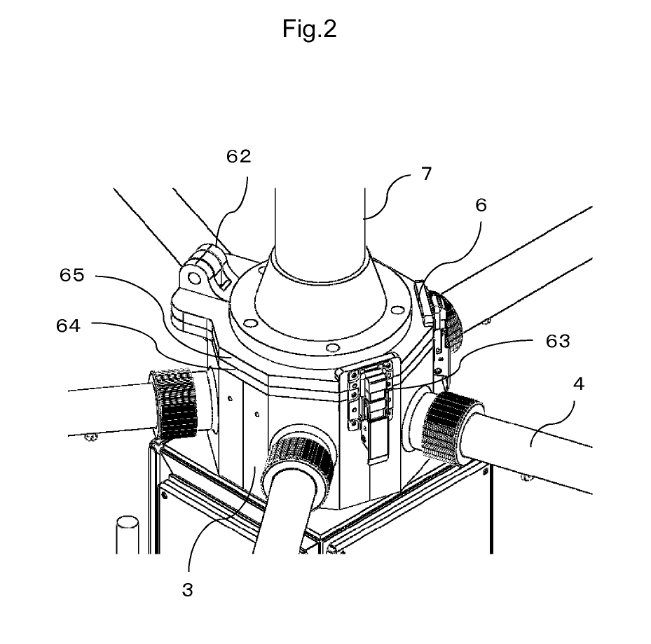

Next, an example will be described in detail with reference to FIGS. 1 and 2 about the structure of the first exemplary embodiment of the multi-band antenna according to the present invention. FIG. 1 is a schematic diagram of the multi-band antenna which is an exemplary embodiment of the present invention. A radio wave monitoring apparatus 1 according to the present invention includes a lower part support pole 2, an L band antenna relay block 3, a hinge part 6, a central part support pole 7, an M band antenna relay block 8, an upper part support pole 11 and an H band antenna 12.

One end face of the lower part support pole 2 is installed in the ground, and the other end face of the lower part support pole 2 is connected to the L band relay block 3.

The L band antenna relay block 3 has five L band antenna stays 4 on the side face of the L band antenna relay block 3, and five L band antennas 5 for receiving radio waves of a low frequency band (below 1 GHZ, for example) which are provided at respective tips of the L band antenna stays 4. The L band antenna 5 is mounted so that it may become vertical to the L band antenna stay 4. The center of the L band antenna 5 is fixed on the L band antenna stay 4. One end face of the L band antenna relay block 3 is connected to the lower part support pole 2, and the other end face of the L band antenna relay block 3 is connected to the hinge part 6.

One end face of the hinge part 6 is connected to the L band antenna relay block 3, and the other end face of the hinge part 6 is connected to the central part support pole 7.

One end face of the central part support pole 7 is connected to the hinge part 6, and the other end face of the central part support pole 7 is connected to the M band antenna relay block 8.

The M band antenna relay block 8 has five M band antenna stays 9 on the side face of the M band antenna relay block 8, and five M band antennas 10. Five M band antennas 10 are provided at respective tips of the M band antenna stays 9, and receive radio waves of a frequency band (1 GHZ-2 GHZ, for example) higher than the L band antenna 5. The M band antenna 10 is mounted so that it may become vertical to the M band antenna stay 9, and the center of the M band antenna 10 is fixed on the M band antenna stay 9. One end face of the M band relay block 8 is connected to the central part support pole 7, and the other end face of the M band relay block 8 is connected to the upper part support pole 11.

One end face of the upper part support pole 11 is connected to the M band antenna relay block 8, and the other end face of the upper part support pole 11 is connected to the H band antenna 12.

The H band antenna 12 receives radio waves of a frequency band (3 GHZ-4 GHZ, for example) higher than the M band antenna 10. The H band antenna 12 is connected to the upper part support pole 11.

FIG. 2 is a figure which indicates details of the hinge part 6. The hinge part 6 includes an inclination axis 62, a catch bolt 63, a first piece 64 and a second piece 65.

The length of the lower part support pole 2 and the central part support pole 7 is so designed as the lower part support pole 2 being longer than the central part support pole 7. By doing that, work efficiency can be achieved because the M band antenna 10 stops before touching the ground when the central part support pole 7 is inclined. More desirably, the length of the lower part support pole 2 is to be designed so that it is longer than the total length of adding the central support pole 7 and the upper part support pole 11.

Here, when viewing the ground vertically from above, the inclination axis 62 is provided so that it may be located between two L band antenna stays 4. Thus, by configuring like this, interference between the central part support pole 7 and the L band antenna stay 4 can be avoided, and the M band antenna 10 and the H band antenna 12 can be brought closer to the ground.

The first piece 64 is fixed with bolts on a top face of the L band antenna connecting block 3, and the second piece 65 is fixed with bolts on a bottom end of the central part support pole 7.

The M band antenna 10 and the H band antenna 12 get closer to the ground direction due to the central part support pole 7 being bent in the ground direction by opening the first piece 64 and the second piece 65 around the inclination axis 62.

The catch bolt 63 can lock and release the first piece 64 and the second piece 65 as a unit. The first piece 64 is fixed on an end portion of the lower part support pole. The second piece 65 is fixed on an end portion of the central part support pole 7.

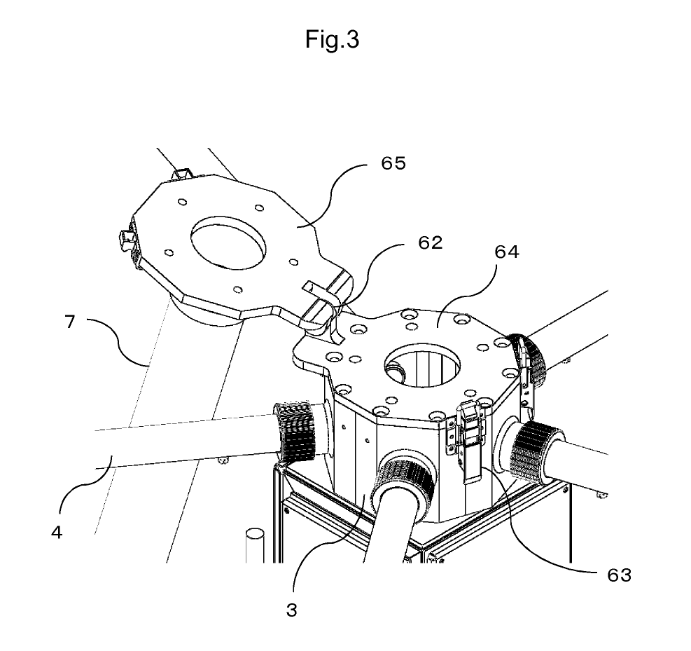

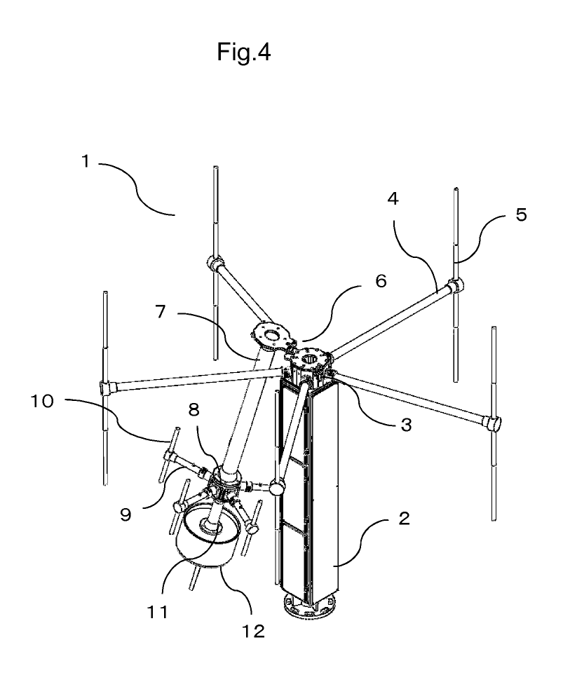

Next, an example will be described in detail with reference to FIGS. 3 and 4 about the structure of the exemplary embodiment of the multi-band antenna according to the present invention.

FIG. 3 is a detail view indicating a state that the lock of the catch bolt 63 is released. The first piece 64 and the second piece 65 are separated, and the central part support pole 7 inclines to the ground direction around the inclination axis 62.

FIG. 4 is a general view indicating a state that the lock of the catch bolt 63 is released. The central part support pole 7 inclines as indicated by the description of FIG. 3. By making an angle formed by the inclined central part support pole 7 and the lower part support pole 2 be below 90-degree, the M band antenna 10 and the H band antenna 12 come to exist in a range where workers can perform the work. In other words, by the movement of rotational transfer of the central part support pole 7, the M band antenna 10 and the H band antenna 12 come closer to the antenna installation surface.

As mentioned above, by the central part support pole 7 inclining, the M band antenna 10 and the H band antenna 12 can be lowered to a place near the ground, and efficiency of the work which performs replacement and repair of the M band antenna and the H band antenna can be improved.

### Second Exemplary Embodiment

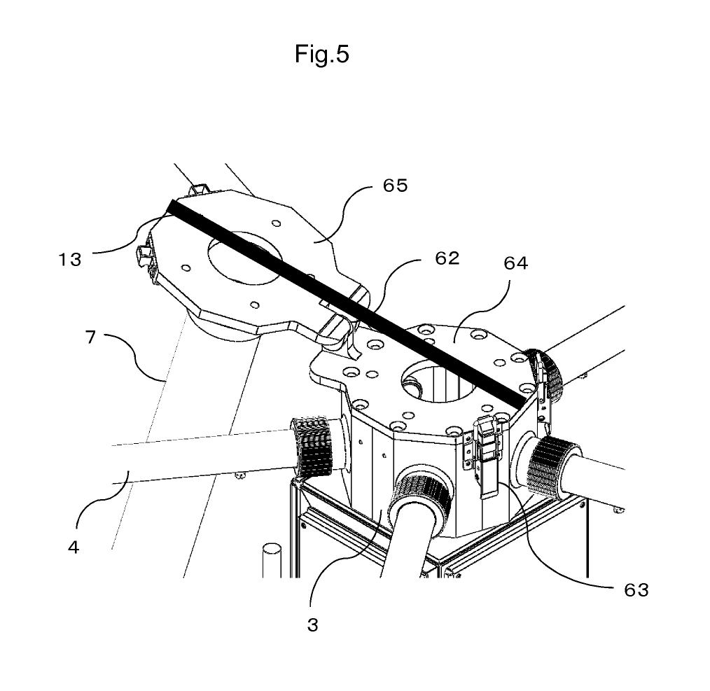

Next, an example will be described in detail with reference to FIG. 5 about the structure of the second exemplary embodiment of the multi-band antenna in the present invention.

According to the second embodiment, it is characterized by newly providing a fixing band 13 which fixes the central part support pole which has inclined.

Specifically, one end of the fixing band 13 is connected to the first piece 64, and the other end of the fixing band 13 is connected to the second piece 65. The length of the fixing band 13 is set as a predetermined length by which the central part support pole 7 does not touch the lower part support pole 2. More specifically, the length of the fixing band 13 is determined so that an angle formed by the central part support pole 7 and the lower part support pole 2 becomes 45-degree.

By configuring as stated above, the central part support pole 7 can be fixed because it balances the tensile strength of the fixing band 13 and gravity on the central part support pole 7. Therefore, work efficiency of workers can be improved because it can reduce movement of the central part support pole at the time of antenna replacement.

Here, the embodiment using the fixing band 13 has been described in the present exemplary embodiment. However, it may provide a mechanism which fixes the central part support pole 7. It also may be the structure which provides a cradle which supports the central part support pole 7.

Further, although the fixing band 13 has the structure that the length is fixed as a prescribed length in the present exemplary embodiment, it may be the structure having a length adjustment mechanism.

With respect to the part other than the above, the description will be omitted because it is the similar structure to the first exemplary embodiment.

### Third Exemplary Embodiment

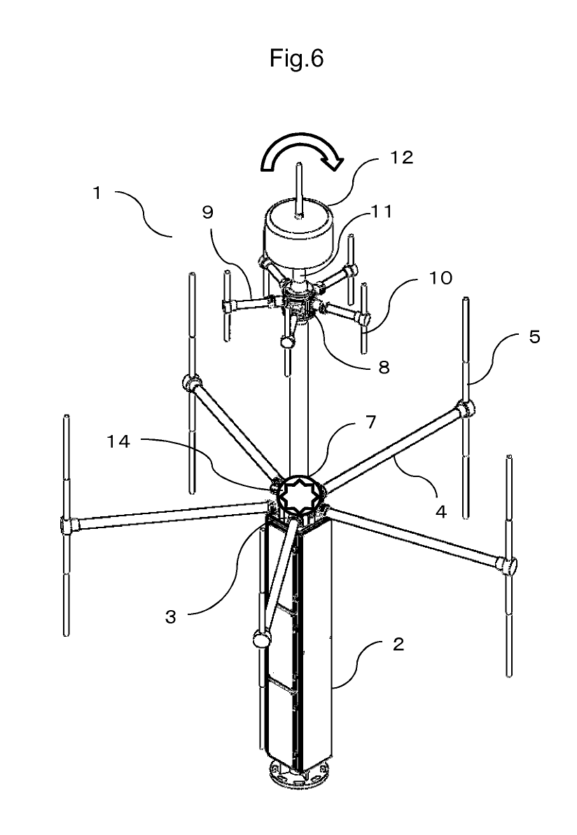

Next, an example will be described in detail with reference to FIG. 6 about the structure of the third exemplary embodiment of the multi-band antenna in the present invention.

According to the first and second exemplary embodiments, the hinge part 6 is adopted as an inclining means. However, in the third exemplary embodiment, it is characterized by newly providing a ratchet 14 as the inclining means.

Specifically, the ratchet 14 is connected to the L band antenna relay block 3. Also, the ratchet 14 is connected to the central part support pole 7.

The ratchet is configured by combining a gear wheel (not shown) and a pawl (claw) (not shown). Each cog of the gear wheel of the ratchet has an oblique direction. Rotating directionality is given by this oblique direction.

The pawl is arranged so that it may lean on the gear wheel, and when the gear wheel rotates in a forward direction (the direction suitable for rotating), the pawl climbs over cogs easily and gets settled at the original position again. When making the gear wheel rotate in an opposite direction (the direction not suitable for rotating), it is configured not to be rotated because the pawl gets stuck into a cog. When it is the premise that the central part support pole 7 inclines to a right direction as shown in FIG. 6, the forward direction in the present invention is the direction indicated by an arrow in FIG. 6, and the opposite direction is an opposite direction in the direction indicated in FIG. 6.

In other words, when inclining the central part support pole 7, it is inclined to the desired angle by removing the pawl, and performing necessary work after fixing by the pawl, then, when the central part support pole 7 is to be returned to the original position, it is rotated to the forward direction of the ratchet 14.

By adopting the ratchet, because the central part support pole 7 can be inclined step by step, the height of the M band antenna and the H band antenna can be adjusted freely by workers. Therefore, the working efficiency of workers can be improved. Further, as it is a ratchet mechanism and also it has the effect of inclination restraint, the fixing band 14 becomes unnecessary because it is also possible for the ratchet mechanism to take on a role as a fixation mechanism of the central part support pole.

With respect to the part other than the above, the description will be omitted because it is the similar structure to the first exemplary embodiment.

### Fourth Exemplary Embodiment

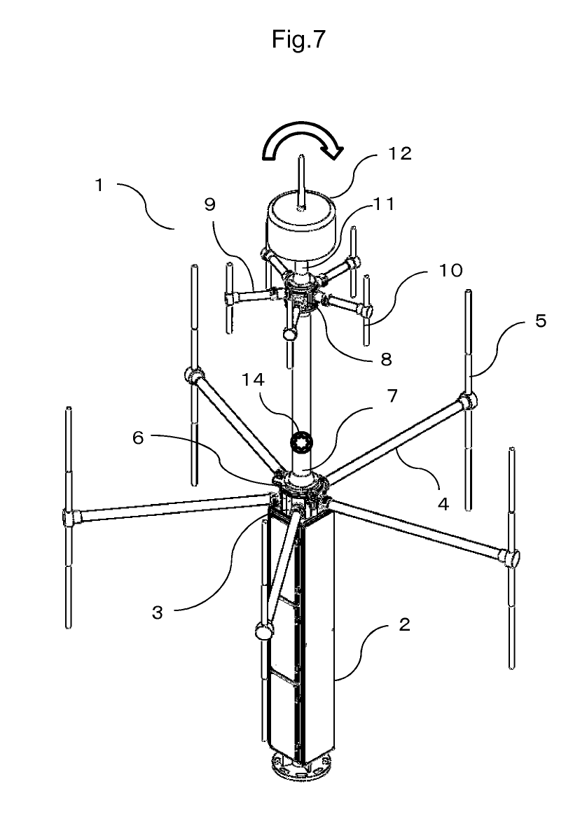

Next, an example will be described in detail with reference to FIG. 7 about the structure of the fourth exemplary embodiment of the multi-band antenna in the present invention.

Although the structure having a single inclining means is disclosed in the first to third exemplary embodiments, it is characterized by providing a plurality of inclining means in the fourth exemplary embodiment. Specifically, it will be described with referring to FIG. 7. In the form of FIG. 7, one end face of the hinge part 6 is connected to the L band antenna relay block 3, and the other end face of the hinge part 6 is connected to the central part support pole 7. The ratchet 14 is provided at the central part support pole 7. Therefore, the multi-band antenna of the fourth exemplary embodiment has the hinge part 6 and the ratchet 14 as the inclining means.

Because the multi-band antenna of the fourth exemplary embodiment has two above-mentioned inclining means and it results two supporting points for inclination exist, the position of the M band antenna unit and the H band antenna unit can be moved and arranged to a place where it is easier to work for workers. With respect to the part other than the above, the description will be omitted because it is the similar structure to the first exemplary embodiment.

The present invention can be used, for example, for a multi-band antenna.

Above, the configuration of the preferred embodiment of the present invention has been described. Although the whole or part of the exemplary embodiments disclosed above can be described as the following examples and supplementary notes, the present invention is not limited to the following configuration.

### EXAMPLE 1

According to the present exemplary embodiment, although it has been described using the antenna having three frequency bands of the L band antenna, the M band antenna and the H band antenna, the present invention can be applied as long as it is the multi-band antenna having two or more antennas.

### EXAMPLE 2

According to the present exemplary embodiment, although there are five each of the L band antenna stay 4 and the M band antenna stay 9, it is not limited to five and it may be any number as long as it can receive a frequency band.

### EXAMPLE 3

According to the present exemplary embodiment, although the catch bolt is adopted, it is not limited in particular as long as it is the structure which can lock the first piece 64 and the second piece 65 as a single unit. Specifically, the structure can be considered such that providing a magnet at the first piece 64 and the second piece 65 and locking them using the magnetic attraction force, and fixing them completely with bolts or screws.

### EXAMPLE 4

According to the present exemplary embodiment, although the first piece 64 of the hinge part 6 and the L band antenna relay block 3 are separately formed, they may be formed as one integrated body. Further, although the second piece 65 and the central part support pole 7 are also separately formed in the present exemplary embodiment, they may be formed as one integrated body.

### Supplementary Note 1

A multi-band antenna, comprising:
a lower part support pole of which one end part is installed in an installation surface;
a first band antenna unit connected to the lower part support pole;
an inclining means connected to the other end of the lower part support pole;
a central part support pole which is located on a center axis of the lower part support pole and is connected to the inclining means; and
a second band antenna unit connected to the central part support pole, and
wherein the central part support pole inclines to a direction of the installation surface by the inclining means.

### Supplementary Note 2

The multi-band antenna according to supplementary note 1, wherein the inclining means inclines the central part support pole 7 such that an angle formed by the central part support pole 7 and the lower part support pole 2 to be below 90-degree.

### Supplementary Note 3

The multi-band antenna according to supplementary note 1 or 2, wherein the first band antenna unit includes a plurality of antenna stays wherein the plurality of antenna stays are provided in a different direction from a central axis direction of the lower part support pole, and wherein the central part support pole inclines to a direction between the plurality of antenna stays when viewing the ground vertically from above.

### Supplementary Note 4

The multi-band antenna according to any one of supplementary notes 1 to 3, wherein the inclining means is a hinge part, and wherein one piece of the hinge part is provided at an end part of the lower part support pole, and the other piece of the hinge part is provided at an end part of the central part support pole.

### Supplementary Note 5

The multi-band antenna according to any one of supplementary notes 1 to 3, wherein the inclining means is a ratchet.

### Supplementary Note 6

The multi-band antenna according to any one of supplementary notes 1 to 5, comprising:
a fixing means which is configured to fix the central part support pole in an inclining state in case where the central part support pole is inclining.

### Supplementary Note 7

The multi-band antenna according to supplementary notes 6, wherein the fixing means is a fixing band.

### Supplementary Note 8

The multi-band antenna according to supplementary notes 4, comprising: a hinge locking means which is configured to lock the one piece and the other piece of the hinge part.

### Supplementary Note 9

The multi-band antenna according to supplementary notes 8, wherein the hinge locking means is a catch bolt.

### Supplementary Note 10

A multi-band antenna, comprising:
a lower part support pole of which one end part is installed in an installation surface;
a first band antenna unit connected to the other end part of the lower part support pole;
a hinge part locating on the same axis of the lower part support pole, and connected to the first band antenna unit;
a central part support pole locating on the same axis of the lower part support pole, and an end part thereof is connected to the hinge part;
a second band antenna unit connected to the other end part of the central part support pole;
an upper part support pole locating on the same axis of the central part support pole, and an end part thereof is connected to the second band antenna unit; and
a third band antenna unit connected to the other end part of the central part support pole, and
wherein the central part support pole rotates on the hinge part as a center.

### DESCRIPTION OF THE REFERENCE NUMERALS

1 radio wave monitoring apparatus

2 lower part support pole

3 L band antenna relay block

4 L band antenna stay

5 L band antenna

6 hinge part

61 inclination axis

62 catch bolt

63 first piece

64 second piece

7 central part support pole

8 M band antenna relay block

9 M band antenna stay

10 M band antenna

11 upper part support pole

12 H band antenna

13 fixing band

14 ratchet

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

What is claimed is:

1. A multi-band antenna, comprising:
a lower part support pole of which one end part is installed in an installation surface;
a first band antenna unit connected to the lower part support pole;
an inclining means connected to the other end of the lower part support pole;
a central part support pole which is located on a center axis of the lower part support pole and is connected to the inclining means; and
a second band antenna unit connected to the central part support pole, and
wherein the central part support pole inclines to a direction of the installation surface by the inclining means.

2. The multi-band antenna according to claim 1, wherein the inclining means inclines the central part support pole 7 such that an angle formed by the central part support pole 7 and the lower part support pole 2 to be below 90-degree.

3. The multi-band antenna according to claim 1, wherein the first band antenna unit includes a plurality of antenna stays wherein the plurality of antenna stays are provided in a different direction from a central axis direction of the lower part support pole, and wherein the central part support pole inclines to a direction between the plurality of antenna stays when viewing the ground vertically from above.

4. The multi-band antenna according to claim 1, wherein the inclining means is a hinge part, and wherein one piece of the hinge part is provided at an end part of the lower part support pole, and the other piece of the hinge part is provided at an end part of the central part support pole.

5. The multi-band antenna according to claim 1, wherein the inclining means includes a ratchet.

6. The multi-band antenna according to claim 1, comprising:
a fixing means which is configured to fix the central part support pole in an inclining state in case where the central part support pole is inclining.

7. The multi-band antenna according to claim 4, comprising:
a hinge locking means which is configured to lock the one piece and the other piece of the hinge part.

8. A multi-band antenna, comprising:
a lower part support pole of which one end part is installed in an installation surface;
a first band antenna unit connected to the other end part of the lower part support pole;
a hinge part locating on the same axis of the lower part support pole, and connected to the first band antenna unit;
a central part support pole locating on the same axis of the lower part support pole, and an end part thereof is connected to the hinge part;
a second band antenna unit connected to the other end part of the central part support pole;
an upper part support pole locating on the same axis of the central part support pole, and an end part thereof is connected to the second band antenna unit; and
a third band antenna unit connected to the other end part of the central part support pole, and
wherein the central part support pole inclines to a direction of the installation surface by the inclining means.
